(19) United States
(12) Patent Application Publication
(10) Pub. No.: US 2012/0262425 A1
(43) Pub. Date: Oct. 18, 2012

(54) DISPLAY DEVICE AND DISPLAY METHOD THEREFOR

(75) Inventors: Cristian Andreola, Spresiano (TV) (IT); Simone Capeleto, Padova (IT); Alessandro Fuser, Preganziol (TV) (IT)

(73) Assignee: OSRAM AG, Muenchen (DE)

(21) Appl. No.: 13/508,368

(22) PCT Filed: Nov. 3, 2010
(86) PCT No.: PCT/EP10/66669

§ 371 Date: Jun. 25, 2012

(30) Foreign Application Priority Data
Nov. 9, 2009 (IT) TO2009A000856

(51) Int. Cl. G06F 3/042

(52) U.S. Cl. 345/175

(57) ABSTRACT

In various embodiments, a device for displaying a signal, including an optical guide defining at least one propagation path for an optical radiation from an injection point of the radiation, in which the optical radiation propagating along this path is subject to attenuation due to being diffused and made visible outside said guide, and at least one source of optical radiation for receiving said signal and generating an optical radiation whose intensity is a function of said signal; said at least one optical radiation source being coupled to said at least one injection point to inject into said guide the optical radiation generated by said radiation source.

### TECHNICAL FIELD

The present description relates to display devices which can also be used if necessary for input and/or command functions. The description has been written with particular attention to the possible use of these devices in the field of man-machine interfaces (MMI), for example those of the type advertised as “user friendly” interfaces.

### DESCRIPTION OF THE RELEVANT PRIOR ART

The rotary knob controls which are conventionally used in numerous pieces of electrical and electronic equipment form an elementary form of interface device which can provide display functions in addition to control functions. This is because the position reached in the rotary movement (indicated, for example, by a pointer or index on the knob) also provides at least an approximate indication of the control position.

Slider controls, used for example in a wide range of electrical and electronic equipment, operate on similar principles; examples of these controls are the sliders normally provided on the control panels of audio/video mixers for either professional or amateur use.

These slider controls are also known in versions which may be described as “virtual”, in which the slider is represented on a display screen, of the liquid crystal type for example. If the screen is of the touch screen type, such as a capacitive touch screen, the user can control the slider displayed on the screen according to principles substantially similar to those of the operation of conventional mechanical sliders, or under conditions such that the control position of the slider also has the function of displaying the level of the controlled signal.

Additionally, in relation to the display function, backlit liquid crystal displays have been shown to have a considerable degree of flexibility as regards their possible fields of application. However, the inventors have found that there are numerous applications in which these devices are excessively complex or costly, in view of the simplicity of the information to be displayed. These devices require the use of advanced production technology and are also subject to limitations concerning the environmental conditions (in relation to the operating temperature, for example).

The same considerations are broadly applicable to display units formed by arrays of light sources (such as LEDs) which can be activated selectively in such a way that the number of LEDs activated indicates the level of the signal displayed. These components can also be rather complicated, for example because of the number of connections required, and are not particularly flexible in terms of applications.

As far as the control function is concerned, however, touch sensors of the capacitive, resistive or other types, such as those based on surface acoustic wave (SAW) technology, have been used increasingly over the years. These sensors usually have low production costs and a considerable simplicity in terms of control. However, the inventors have found that these sensors are not easily integrated with a conventional display function (for the purpose of displaying the control intensity of a signal, for example).

### OBJECT AND SUMMARY OF THE INVENTION

Within this general context there is now an acknowledged need for interfaces, for use in fields including, but not limited to, those of automatic control electronics, amusement or entertainment applications, home automation systems, and the like, which can provide a display function (suitable for integration with a control function if necessary) and which can meet requirements such as the following:
containment of production and assembly costs
compactness
user-friendliness of display and operation
the possibility of producing interfaces which are attractive to users, and
the capacity to withstand adverse environmental conditions (such as heat, dust, various forms of workplace pollution) such as those commonly encountered in the automobile industry.

The object of the present invention is to provide solutions to meet the above requirements.

According to the present invention, this object is achieved by means of a device having the characteristics claimed in the claims below. The invention also relates to a corresponding method.

The claims form an integral part of the technical teachings provided herein in relation to the invention.

Some embodiments are based on the use of components which can act as optical guides for defining at least one propagation path for an optical radiation from an injection point of the radiation, in which the optical radiation propagating along this path is subject to attenuation due to being diffused and made visible outside the component.

Examples of components which can provide this behavior are the components known as “scattering bars”, particularly those of the volume type, and devices formed by the stacking of optical slides in the solid state (“stacked solid slides”). High-attenuation optical fibers are another example of this type of component.

In some embodiments, components of this type can meet the specified requirements in a highly satisfactory way, even in critical environmental conditions (such as environments characterized by the presence of a considerable amount of dust), without the need for costly protection systems.

In some embodiments, the display can be provided by means of color coding mechanisms which facilitate the understanding of the information presented by the display device.

Some embodiments of the invention benefit from the high color resolution capacity of the human eye, by combining different color components from light sources such as LEDs. It may also be possible to use faceplates to enhance the perception of the color coding.

In some embodiments, the benefits of the provision of the display function can be integrated with benefits related to the provision of the control function, particularly as regards the possibility of detecting a control action by the user, for example by using touch sensors to avoid the need for using separate devices such as dimmers, push buttons, mechanical sliders, and the like.

In some embodiments, these display systems can be integrated with touch sensors (such as capacitive, resistive or SAW sensors), enabling these sensors to be integrated with the display unit, using printing techniques if appropriate.

Some embodiments enable implementation to take place at a lower cost than has been achieved previously, by producing a display, using color coding if necessary, based on economical components combined with simple production processes and standard technologies.

Some embodiments are characterized by a high degree of compactness, an attractive appearance for the user, and high reliability, making them capable of operation even in rather adverse conditions, partly because no moving parts are necessary.

Some embodiments include processors capable of controlling communication systems, even rather advanced ones, such as those using DALI, DMX, TCP/IP, and similar protocols.

Some embodiments are suitable for use in combination with other complementary forms of signaling such as acoustic systems (for example, buzzers) or tactile systems (for example, electromechanical vibration systems).

### BRIEF DESCRIPTION OF THE APPENDED DRAWINGS

The invention will now be described, purely by way of non-limiting example, with reference to the appended drawings, in which:

FIG. 1 shows an embodiment of a display device,

FIG. 2 comprises three parts, indicated by a, b, and c respectively, which are examples of the possible operation of the embodiment of FIG. 1,

FIG. 3 shows an embodiment of a display device,

FIG. 4 comprises three parts, indicated by a, b, and c respectively, which are examples of the possible operation of the embodiment of FIG. 3,

FIG. 5 shows the principle of operation of a component which can be used in one embodiment,

FIG. 6 shows in greater detail a possible embodiment of this component,

FIGS. 7 and 8 illustrate the possibility of integrating a control function in various embodiments, and

FIG. 9 shows an embodiment of the two-dimensional type.

### DETAILED DESCRIPTION OF EMBODIMENTS

The following description illustrates various specific details intended to provide a deeper understanding of the embodiments. The embodiments may be produced without one or more of the specific details, or may use other methods, components, materials, etc. In other cases, known structures, materials or operations are not shown or described in detail, in order to avoid obscuring various aspects of the embodiments.

The reference to “an embodiment” in this description is intended to indicate that a particular configuration, structure or characteristic described in relation to the embodiment is included in at least one embodiment. Therefore, phrases such as “in an embodiment”, which may be present in various parts of this description, do not necessarily refer to the same embodiment. Furthermore, specific formations, structures or characteristics may be combined in a suitable way in one or more embodiments.

The references used herein are purely for convenience and therefore do not define the scope of protection or the extent of the embodiments.

In the figures below, the reference 10 indicates the whole of a source intended to produce, as the signal to be displayed, an electrical signal having a characteristic, such as the intensity, which is to be displayed.

The source in question can be a sensor or an electrical and/or electronic apparatus of any kind. It may, for example, be a potentiometric signal source corresponding to a control position, for example a position relating to the dimming level of a light source.

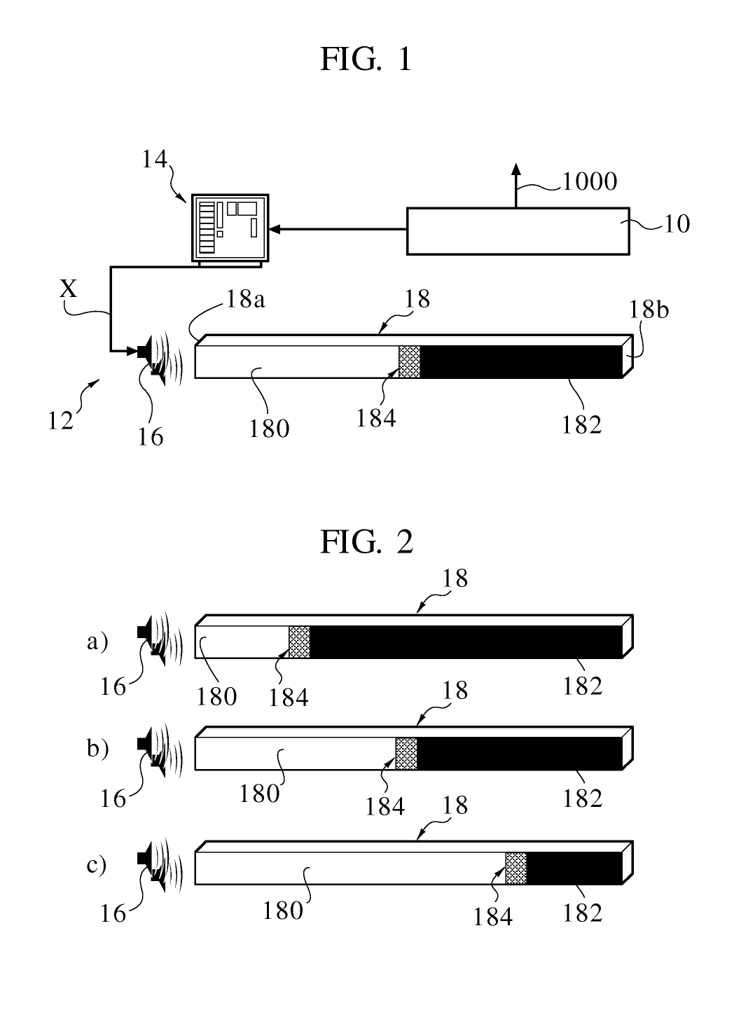

FIGS. 1, 3 and 9 relate to embodiments in which the source 10 is an element which is separate from a display device indicated as a whole by 12. On the other hand, FIGS. 7 and 8 relate to embodiments in which the source 10 is integrated with the display device 12.

The reference numeral 14 indicates a processor, such as a microcontroller, which receives the signal from the source 10 and generates from this signal one or more drive signals for the display device 12. FIGS. 7 and 8 illustrate the possibility of additionally integrating the processor 14 into the display device 12.

Persons skilled in the art will understand, however, that some embodiments can dispense with the processor 14, since the device 12 can be driven directly by the output signal from the source 10.

For the purpose of illustrating the exemplary embodiments considered here, it will be assumed that the display device 12 is intended to operate on a signal x. Furthermore, for simplicity of illustration, it will be assumed that the signal x is a signal standardized to unity, that is to say a signal which can take values in the range from 0 (minimum level) to 1 (maximum level) with continuous or stepped variation.

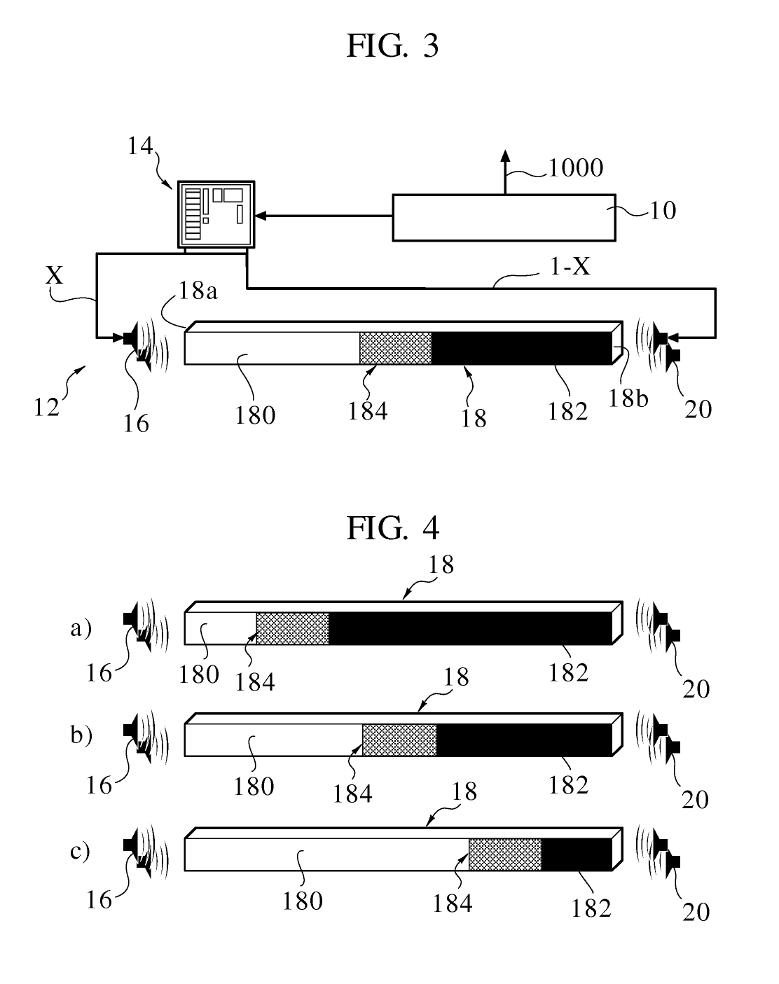

In the embodiment to which FIGS. 3 and 4 relate, a signal 1-x, representing in the complement of the level of the signal from the source 10, is present in addition to the signal x, and therefore the display device 12 operates on a first signal having the value x and a complementary signal having the value 1-x.

It should be remembered that the representation of the signal x is a standardized representation, meaning that the actual value of the drive signal concerned can be disregarded.

In the embodiment of FIGS. 1 and 2, the signal x is supplied to a light source 16 such as an LED. The LED 16 is coupled to an optical guide 18 extending between a first end 18a and a second end 18b. In the embodiments considered here, the guide 18 is assumed to have a rectilinear shape overall, but this shape is not in any way essential.

In the embodiments of FIGS. 1 and 2, the (single) light source 16 supplied with the signal x is coupled to the end 18a. In the embodiments to which FIGS. 3 and 4 relate, there is also a second light source 20, such as an LED, coupled to the second end 18b.

The term “coupled”, used in respect of the link between the optical source or sources 16 and 20 and the corresponding ends 18a and 18b of the optical guide 18, refers to any connecting configuration such that the optical radiation generated by the source 16 or by the sources 16, 20 can be injected or sent into the guide 18 in such a way that this radiation can propagate from the corresponding injection point (the end 18a or 18b) along the propagation path defined by the guide 18.

It will be appreciated that, although this description refers to the use of light sources formed by LEDs, the light sources can be formed, in any of the embodiments, by any light source (such as laser diode, a plasma light source, or the like) which can generate optical radiation whose intensity is a function of, and is therefore representative of, the level (for example, the mean level) of the signal supplied to it.

In the embodiments considered with reference to FIGS. 1 to 4, the optical guide 18 is composed of what is known as a “scattering bar”, particularly one with a volumetric effect. As is known, a scattering bar of this kind forms an optical guide which can define a radiation path within itself for an optical radiation, injected for example from the end 18a which then forms the radiation injection point.

This takes place in conditions such that the radiation propagating along the guide 18 from the end 18a is subject to attenuation due to being diffused and made visible from outside the guide 18.

For example, it may be supposed that the radiation produced by the LED 16 and injected at the end 18a is a light blue radiation and that the material of the scattering bar 18 is colored green.

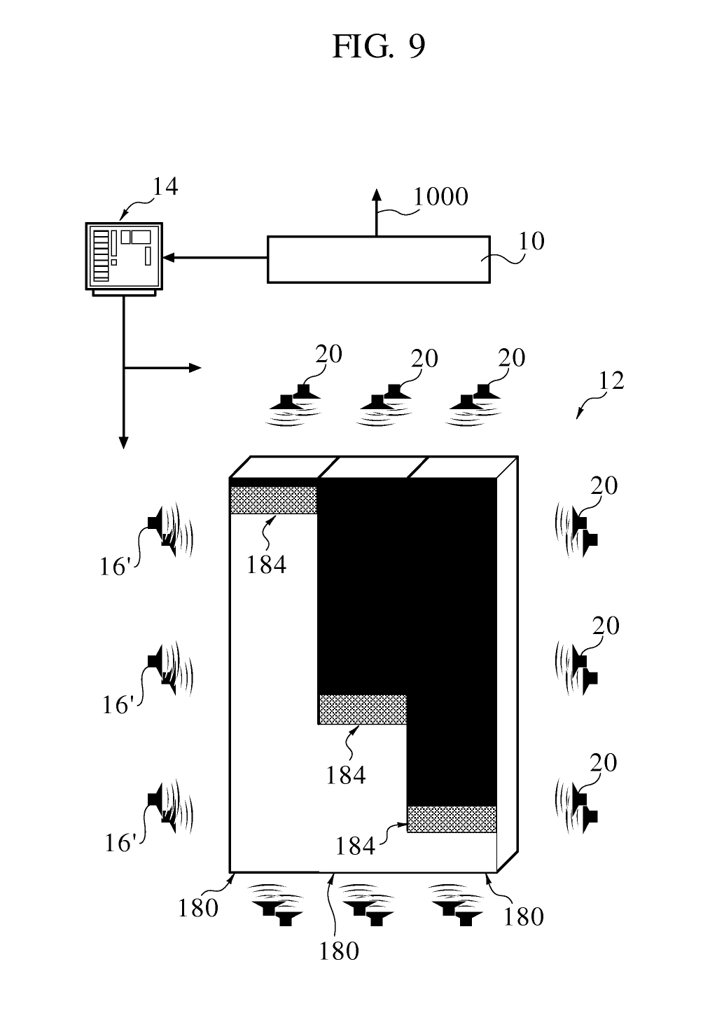

However, the choice of particular color characteristics is not essential for the purposes of the production of the embodiments. Consequently (and also for the sake of clarity and simplicity of illustration), FIGS. 1 to 4 (and also FIG. 9) illustrate the operation of the various embodiments essentially by means of various grey tones (from light to dark). This difference in grey tones is intended to represent the fact that, in the operation of various embodiments, different portions of the guide 18 can be distinguished from each other by making use of the intensity and/or color resolution capacity of the human eye.

With reference to the embodiment of FIG. 1, the radiation produced by the LED 16 and injected into the guide 18 from the injection point represented by the end 18a has an intensity (and therefore a visibility) which is maximal at the injection point and decreases gradually with distance from the injection point. This is a result of the attenuation due to the fact that, when propagating along the guide 18, the radiation is “diffused” (by scattering, by reflection or by other phenomena) to the outside of the guide 18 and is made visible outside the guide 18.

The following zones can therefore be identified along the extension of the guide 18:
a first zone 180, adjacent to the injection point 18a, where the illuminating effect due to the radiation produced by the LED 16 is predominant;
a second zone 182, located at the opposite end 18b of the guide 18, where the effect of the radiation injected at the end 18a is minimal, and is indeed absent; and
an intermediate zone 184, forming a kind of transition zone (generally rather narrow in the case of the embodiment to which FIGS. 1 and 2 relate) between the zones 180 and 182.

For simplicity of illustration, FIGS. 1 and 2 refer to a situation in which the predominance of the illuminating effect due to the radiation generated by the LED 16 in the zone 180, and the reduction or disappearance of the effect of this radiation in the zone 182, correspond to the fact that the zone 180 is “bright” or “illuminated”, while the zone 182 is “dark” or “unlit”, while the zone 184 has an intermediate level of illumination.

The same effect can also be manifested in terms of color characteristics.

For example, referring (in a non-exclusive way) to the color components mentioned above, we may suppose that the illuminating effect in the zone 180 of the radiation generated by the LED 16 (which is assumed to emit a blue radiation) can be perceived as a light blue colored zone. On the other hand, the zone 182, where the illuminating effect of the radiation produced by the LED is minimal or even non-existent, the background color of the guide 18, green for example, is predominant.

The zone 184 therefore has an intermediate color identified approximately as an “emerald green” color; in other words it is a zone in which the blue and green color components are mixed.

As FIG. 2 shows, when the intensity of the signal x used to drive the LED 16 is varied selectively, either continuously or in steps, then the relative extensions of the zones 180 and 182 and consequently the position of the intermediate zone 184 are also varied selectively, in such a way that this intermediate or transition zone moves along the guide 18 as a function of the value of x. In this way, the position of the zone 184 provides an observer of the guide 18 with a visual indication, in other words a display, of the value of x and consequently the value of the signal produced by the source 10.

For example, the three portions a, b, c of FIG. 2 refer, by way of example, to values of x (considered as a signal standardized to unity) equal to ¼, ½ and ¾ respectively.

In the first case, the transition zone 184 is located about a quarter of the way along the guide 18 from the end 18a.

In the second case, the transition zone 184 is located about halfway along the guide 18.

In the third case, the transition zone 184 is located about three quarters of the way along the guide 18 from the end 18a.

Similarly, we may suppose that, when x is zero, and therefore the LED 16 is switched off, the zone 180 (and also the zone 184) practically disappear, and therefore the zone 182 finally occupies the whole extension of the guide 18. Equally, we may suppose that, when the signal x is at its maximum level (with a standardized value of 1), both the zone 182 and the zone 184 disappear almost completely, and therefore the zone 180 occupies the whole longitudinal extension of the guide 18.

The schematic representation in FIG. 2 relates to a hypothetical approximately linear relationship between the value of the signal x and the extension of the zone 180. It will be appreciated that, in particular, different forms of variation can be obtained, depending on the technology used to produce the source 16 and/or the guide 18; for example, the variation may be of a non-linear type such as an exponential variation.

FIGS. 3 and 4 refer to embodiments in which the driving of the display on the guide 18 requires the use of both light sources 16 and 20, which in this case are assumed to operate at different wavelengths such that optical radiations having different wavelengths (which are therefore perceived as different colors) are injected into the guide 18 from the end 18a and from the end 18b respectively. For example, again considering the example described above, the radiations may be an optical radiation in the light blue range (LED 16) and a radiation in the green range (LED 20).

However, it will be appreciated that, even if one of these colors is identical to the background color of the material forming the guide 18, this choice is not in any way essential.

The longitudinal extension of the guide 18 of FIGS. 3 and 4 is divided during the operation of the display device 12, in a substantially similar way to that described above with reference to FIGS. 1 and 2, into three zones:
a first zone 180, adjacent to the end 18a, in which the illuminating effect of the radiation generated by the first optical source 16 (such as a light blue radiation) is predominant;
a second zone 182, located at the opposite end 18b of the guide 18, in which the illuminating effect of the radiation generated by the source 20 (such as a radiation with a color in the green range) is predominant; and
an intermediate region 184 in which there is a transition and mixing of the aforesaid two color components.

In this case, the light sources 16 and 20 are driven by two signals, x and (1-x), which represent in a complementary way the level of the signal to be displayed. For example, referring again for the sake of simplicity to values standardized to unity, in the example of FIGS. 3 and 4, when the LED 16 is supplied with a signal having an intensity of x, the LED 20 is driven by a signal having a complementary intensity of 1-x.

Thus, for example, with reference to what is illustrated in the three parts a), b) and c) of FIG. 4:
when the signal x is equal to ¼ (and therefore the signal 1-x is equal to ¾), the zone 180 (adjacent to the end 18a) occupies approximately ¼ of the longitudinal extension of the bar 18, while the zone 182 (adjacent to the end 18b) occupies approximately ¾ of the longitudinal extension of the bar 18;
when x is equal to ½, in which case 1-x is also equal to ½, the two zones 180 and 182 have practically the same extension, with the intermediate transition region 184 located halfway along the guide 18; and
when the signal x is equal to ¾ (and therefore the signal 1-x is equal to ¼), the zone 180 (adjacent to the end 18a) occupies approximately ¾ of the longitudinal extension of the bar 18, while the zone 182 (adjacent to the end 18b) occupies approximately ¼ of the longitudinal extension of the bar 18.

In this case also, when the signal x has a value of 0, the zone 182, in which the illuminating effect of the source 20 is present, occupies practically the whole of the longitudinal extension of the guide 18, since in this case the signal 1-x has a value of one. In a complementary way, when the signal x is equal to 1 and the signal 1-x is at the level of 0, it is the zone 180 that occupies practically all of the guide 18.

Again, it will be appreciated that the embodiments are not in any way limited to a linear correlation between the signal intensity and the illuminating effect. However, it will be appreciated that the “push-pull” configuration shown in FIGS. 3 and 4 is suitable for providing a reasonably precise linear correlation between the position reached by the transition zone 184 and the value of the signal x.

The preceding description, provided with reference to FIGS. 1 and 4, has considered by way of example the fact that the guide takes the form of a scattering bar, particularly a volumetric scattering bar.

It will also be appreciated that the present description, which refers to the presence of three zones, is purely exemplary in nature. The number of zones which can be perceived as optically distinct (with a greater or lesser degree of distinguishability) can be greater.

However, there are other ways of producing optical guides which can define at least one propagation path for an optical radiation from a point of injection of the radiation in which the optical radiation propagating along this propagation path is subject to attenuation due to being diffused and made visible from outside the guide.

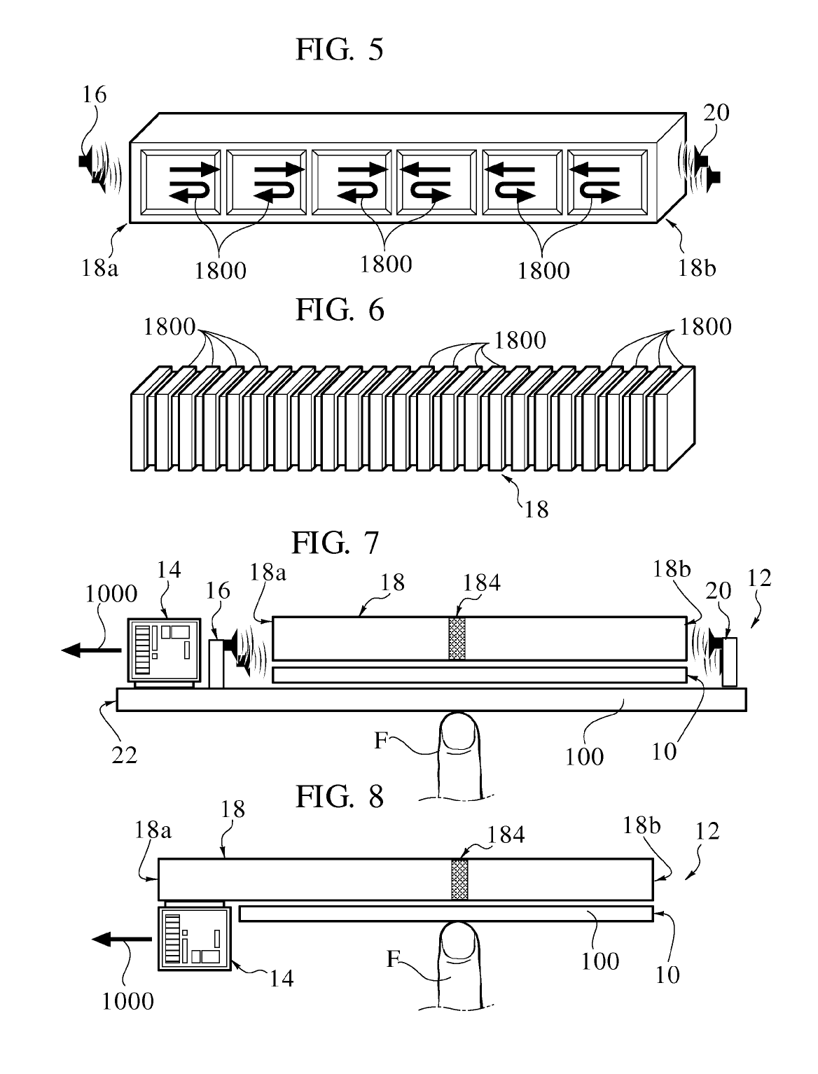

FIGS. 5 and 6 refer to the possibility of producing the guide in the form of a stack of solid/hollow optical radiation propagation structures of the type currently known in the art as “solid slide”.

As shown schematically in FIG. 5, the radiation injected from each end of the stack is subjected, while passing through each “slide” in the stack, to a double mechanism of i) transmission (or more correctly, refraction), with consequent continuation of the propagation along the guide 18, and ii) reflection, which causes a corresponding fraction of the optical radiation to be diffused and made visible from outside the guide 18.

As regards the general criteria for operation, for the embodiment shown in FIGS. 5 and 6 the general criteria which apply are the same as those described above with reference to FIGS. 1 to 4 (this is true, for example, of the possibility of injecting the optical radiation from one or both of the ends of the guide 18).

When the solid slide stack solution shown in FIGS. 5 and 6 is used, it is possible, for example, to modify the attenuation law of the radiation propagating along the guide 10 (in order to obtain an exponential decay, for example).

Although the zones 180, 182 and 184 substantially correspond to continuous variations (or “shades”) of luminosity and/or color in the case of a scattering bar as shown in FIGS. 1 to 4, the zones in question in the guide shown in FIGS. 5 and 6, which is composed of a stack of discrete elements 1800, tend to appear essentially as zones each of which occupies a specific number of elements 1800. This creates a small difference in the display action (which, to a certain degree, is similar to the display action obtained with linear arrays of LEDs).

In the embodiment shown in FIGS. 5 and 6, it is unnecessary to use materials capable of creating volumetric scattering phenomena, because use is made of the discontinuities or interfaces present in the stack of elements 1800 in order to produce the desired effect of refraction and reflection.

FIG. 9 is a schematic illustration of the possibility of applying the general criterion of operation described above to display structures of the two-dimensional type which can be considered, for example, as being derived from the coupling of a plurality of guides 18 of the type considered above, with the guides adjacent to each other, thus making it possible to replace the single light source 16 (and 20 if necessary) with matrices of light sources, in the form of matrices or arrays of LEDs for example.

Additionally, FIG. 9 shows the possibility of extending the operating mechanism described above (at least in relation to wave guides 18, which are based on volumetric scattering phenomena) to two-dimensional operation, by using the display mechanism described above with reference to FIGS. 1 to 4, in both the vertical and the horizontal directions in FIG. 9, using further light sources 16′ and 20′ positioned on the other two sides of a display unit whose overall shape is two-dimensional (being of a square, rectangular, circular, or other type). A corresponding illustration of the display action has not been provided here, in order to avoid excessively complex representations which would be difficult to reproduce. In other words, FIG. 9 shows embodiments in which the structure acting as an optical guide defines a plurality of propagation paths, coplanar with each other, for an optical radiation.

Once again, it will be appreciated that the reference to guides based on volumetric scattering phenomena and/or on solid slide stacks is provided purely by way of example, since embodiments of the solution described here can use a normal high-attenuation optical guide, for example, as the wave guide 18.

FIGS. 7 and 8 refer to the possibility of coupling a display device 12 as considered above (in any of the embodiments described or mentioned herein) to a signal source 10, composed, for example, of a touch sensor (of any known type, for example capacitive, resistive or SAW) which can supply the light source or sources 16, 20 (using the processor 14 if necessary) with the signal x, and if necessary the signal 1-x, used for the purposes of the display.

In the embodiment of FIG. 7, the touch sensor 100 is a linear sensor which is coextensive with the guide 18, and which is integrated with the display device 12 by mounting it on a printed circuit board (PCB) 22 forming a common support structure.

FIG. 8 shows the possibility (which is present, for example, when the guide 18 is composed of a plastic material which partially transmits the radiation with a volumetric scattering phenomenon) of producing the touch sensor 100 by applying it directly (by printing for example) to the body of the guide 18. In some embodiments, the guide 18 can be produced from a flexible material and the touch sensor 100 can be coupled (for example by printing or affixing with adhesive) to the guide 18 and is also flexible, thus enabling a highly compact solution to be achieved.

The illustrated device can be adjusted (by using the processor 14 for example) by coordinating the operation of the touch sensor 100 and the display device 12 in such a way that the display of the device 12 (shown schematically in FIGS. 7 and 8 as the position of the transition zone 184) corresponds to the position in which the user's finger F touches the touch sensor 100, thus providing a functionality corresponding for all purposes to the functionality conventionally provided by conventional sliders or mechanical sliding devices.

In FIGS. 1, 3, 7, 8 and 9, the reference 1000 indicates that the signal produced by the source 10 (which, for example, may be the touch sensor 100 in FIGS. 7 and 8) can be made available on an output line (located upstream or downstream of the processor 14, if present) in such a way that it can be used to control a control function (such as the control of the volume of an acoustic signal) in a coordinated way with the display of the device 12.

Naturally, the principle of the invention remaining the same, the details of construction and the forms of embodiment may be varied widely with respect to those illustrated, which have been given purely by way of non-limiting example, without thereby departing from the scope of protection of the invention as defined in the attached claims. This is true, for example, of the possible integration in equipment for which interaction with the user is required, such as lamps with controllable intensity, color or color temperature (such as “tunable white” lamps).

1. A device for displaying a signal, comprising:
an optical guide defining at least one propagation path for an optical radiation from an injection point of the radiation, in which the optical radiation propagating along this path is subject to attenuation due to being diffused and made visible outside said guide, and
at least one source of optical radiation for receiving said signal and generating an optical radiation whose intensity is a function of said signal; said at least one optical radiation source being coupled to said at least one injection point to inject into said guide the optical radiation generated by said radiation source.

2. The device as claimed in claim 1, characterized in that said optical guide has a first color and said at least one radiation source generates an optical radiation having a second color which is different from said first color.

3. The device as claimed in claim 1, characterized in that:
said optical guide defines an optical radiation propagation path extending between a first injection point and a second injection point of the radiation into said optical guide,
a first and a second optical radiation source are provided and are coupled, respectively, to said first and to said second injection point of the radiation, and
said first and said second source operate at different wavelengths, thus generating optical radiations which are distinct in terms of color.

4. The device as claimed in claim 3, comprising a processing circuit for generating a first and a second drive signal for said first and said second optical radiation source, characterized in that said first and said second drive signal represent in a complementary way the signal to be displayed.

5. The device as claimed in claim 1, characterized in that said at least one optical radiation source is an LED.

6. The device as claimed in claim 1, characterized in that said optical guide is in the form of a bar with at least one optical radiation source coupled to one of the ends of said bar.

7. The device as claimed in claim 1, characterized in that said optical guide produces the volumetric scattering of said optical radiation.

8. The device as claimed in claim 1, characterized in that said optical wave guide is a stack of discrete elements in which said optical radiation is subjected to a refraction and reflection mechanism.

9. The device as claimed in claim 1, comprising a touch sensor for generating said signal.

10. The device as claimed in claim 9, characterized in that said touch sensor is coextensive with said optical guide and is preferably printed or applied on the optical guide.

11. The device as claimed in claim 10, characterized in that said optical guide and said touch sensor are flexible.

12. The device as claimed in claim 1, characterized in that said optical guide defines a plurality of propagation paths for an optical radiation, the paths being coplanar with each other.

13. A method for displaying a signal, comprising:
providing an optical guide defining at least one propagation path for an optical radiation from an injection point of the radiation, in which the optical radiation propagating along this path is subject to attenuation due to being diffused and made visible from outside said guide, and
injecting into said optical guide from said injection point an optical radiation whose intensity is a function of the signal to be displayed.
